(19) United States
(12) Patent Application Publication
(10) Pub. No.: US 2026/0057492 A1
(43) Pub. Date: Feb. 26, 2026

(54) APPARATUS OF DENOISING TIME-LAPSE IMAGE DATA, METHOD OF DENOISING TIME-LAPSE IMAGE DATA, AND COMPUTER READABLE MEDIUM HAVING PROGRAM FOR PERFORMING THE METHOD

(71) Applicant: Korea Advanced Institute of Science and Technology, Daejeon (KR)

(72) Inventors: Young-Gyu YOON, Daejeon (KR); Minho EOM, Daejeon (KR); Seungjae HAN, Daejeon (KR)

(73) Assignee: Korea Advanced Institute of Science and Technology, Daejeon (KR)

(21) Appl. No.: 18/580,758

(22) PCT Filed: Oct. 25, 2023
(86) PCT No.: PCT/KR2023/016669

§ 371 Date: Apr. 23, 2025

(30) Foreign Application Priority Data
Jul. 14, 2023 (KR) 10-2023-0091724

(51) Int. Cl. G06T 5/70; G06T 5/50; G06T 5/60

(52) U.S. Cl. CPC G06T 5/70; G06T 5/50; G06T 5/60; G06T 2207/20084

(57) ABSTRACT

Apparatus for removing a noise in a time-lapse image includes a center frame processing convolutional neural network, a peripheral frame processing convolutional neural network and an information combining convolutional neural network. The center frame processing convolutional neural network is configured to receive a current frame of an input image, and output a center processing value. The peripheral frame processing convolutional neural network is configured to receive a plurality of past frames adjacent to the current frame and a plurality of future frames adjacent to the current frame, and output a peripheral processing value. The information combining convolutional neural network is configured to calculate the center processing value and the peripheral processing value, and output an output image. The center frame processing convolutional neural network does not refer to a center pixel of the current frame.

### TECHNICAL FIELD

Embodiments of the present inventive concept relate to an apparatus for removing a noise in a time-lapse image, a method for removing a noise in a time-lapse image, and a computer-readable recording medium on which a program for executing the method on a computer is recorded. More particularly, embodiments of the present inventive concept relate to an apparatus for removing a noise in a time-lapse image capable of removing a noise with high performance without separate learning data, a method for removing a noise in a time-lapse image, and a computer-readable recording medium on which a program for executing the method on a computer is recorded.

### BACKGROUND

Conventionally, in order to remove a noise from a time-lapse image, a plurality of algorithms have been developed based on Noise2Noise, which is a method for removing a noise by training a convolutional neural network by using two images having identical signals and mutually different noises as an input and an output.

Noise2Noise is a method for training a neural network configured to remove a noise by training the neural network by using images having mutually different noises and signals other than the noises, which are identical to each other, as targets instead of training the neural network by using an image having a noise as an input and a clean image as a target image. When this method is used, a noise removal neural network may be trained without a clean image, whereas a pair of images having mutually different noises and identical signals may be required as learning data.

Such algorithms have been further developed so that a plurality of papers have recently been published in a sister journal of the journal Nature. The algorithms have naturally used availability of application of a Noise2Noise framework by considering adjacent frames in time-lapse image data as images having identical signals and mutually different noises, and have showed that noise removal may be performed with very excellent performance as compared with existing algorithms.

Since such algorithms are fundamentally based on similarity between the adjacent frames in the time-lapse image data, the algorithms may not respond to a rapid change in the image. In other words, even when a rapid change actually exists in a specific frame, the algorithm may remove such a change, which may distort information included in the image.

In a case where a rapid change exists in an image as described above, an algorithm for removing a noise through low-rank approximation of image data based on singular value decomposition (SVD) has been known to exhibit better performance than machine learning-based algorithms.

### DETAILED EXPLANATION OF THE INVENTION

### Technical Purpose

An object of the present inventive concept is to provide an apparatus for removing a noise in a time-lapse image, capable of removing the noise in the time-lapse image and restoring time series information included in original image data.

Another object of the present inventive concept is to provide a method for removing the noise in the time-lapse image, capable of removing the noise in the time-lapse image and restoring the time series information included in the original image data.

Another object of the present inventive concept is to provide a non-transitory computer-readable storage medium having stored thereon program instructions of the method for removing the noise in the time-lapse image.

### Technical Solution

In an example apparatus for removing a noise in a time-lapse image according to the present inventive concept, the apparatus includes a center frame processing convolutional neural network, a peripheral frame processing convolutional neural network and an information combining convolutional neural network. The center frame processing convolutional neural network is configured to receive a current frame of an input image, and output a center processing value. The peripheral frame processing convolutional neural network is configured to receive a plurality of past frames adjacent to the current frame and a plurality of future frames adjacent to the current frame, and output a peripheral processing value. The information combining convolutional neural network is configured to calculate the center processing value and the peripheral processing value, and output an output image. The center frame processing convolutional neural network does not refer to a center pixel of the current frame.

In an embodiment, the center frame processing convolutional neural network may be configured to further receive the peripheral processing value.

In an embodiment, the peripheral frame processing convolutional neural network may refer to a center pixel of the past frame and a center pixel of the future frame.

In an embodiment, an impulse response of the center frame processing convolutional neural network may have an impulse value for an impulse area having a predetermined size, which surrounds the center pixel of the current frame, without having a center impulse value corresponding to the center pixel of the current frame.

In an embodiment, the center frame processing convolutional neural network may include a convolution operation, and a plurality of dilated convolution operations sequentially disposed and configured to receive a result of the convolution operation. A size of a kernel of the dilated convolution operation may be greater than a size of a kernel of the convolution operation.

In an embodiment, the kernel of the convolution operation may have a first value in a first row and a first column, a second value in the first row and a second column, a third value in the first row and a third column, a fourth value in a second row and the first column, a fifth value in the second row and the third column, a sixth value in a third row and the first column, a seventh value in the third row and the second column, and an eighth value in the third row and the third column without having a value in the second row and the second column corresponding to the center pixel of the current frame.

In an embodiment, an impulse response of the convolution operation may have a first impulse value in a first row and a first column, a second impulse value in the first row and a second column, a third impulse value in the first row and a third column, a fourth impulse value in a second row and the first column, a fifth impulse value in the second row and the third column, a sixth impulse value in a third row and the first column, a seventh impulse value in the third row and the second column, and an eighth impulse value in the third row and the third column without having an impulse value in the second row and the second column corresponding to the center pixel of the current frame.

In an embodiment, a kernel of a first dilated convolution operation may have a first value in a first row and a first column, a second value in the first row and a third column, a third value in the first row and a fifth column, a fourth value in a third row and the first column, a fifth value in the third row and the fifth column, a sixth value in a fifth row and the first column, a seventh value in the fifth row and the third column, and an eighth value in the fifth row and the fifth column without having a value in the third row and the third column corresponding to the center pixel of the current frame, and without having values in a second row, a fourth row, a second column, and a fourth column.

In an embodiment, an impulse response of the first dilated convolution operation may have impulse values in areas other than a fourth row and a fourth column corresponding to the center pixel of the current frame, respectively, without having an impulse value in the fourth row and the fourth column in a matrix having seven rows and seven columns.

In an embodiment, a kernel of a second dilated convolution operation may have a first value in a first row and a first column, a second value in the first row and a fifth column, a third value in the first row and a ninth column, a fourth value in a fifth row and the first column, a fifth value in the fifth row and the ninth column, a sixth value in a ninth row and the first column, a seventh value in the ninth row and the fifth column, and an eighth value in the ninth row and the ninth column without having a value in the fifth row and the fifth column corresponding to the center pixel of the current frame, and without having values in second to fourth rows, sixth to eighth rows, second to fourth columns, and sixth to eighth columns.

In an embodiment, the center frame processing convolutional neural network may not refer to a center pixel group of the current frame, which includes the center pixel of the current frame and a plurality of peripheral pixels adjacent to the center pixel.

In an embodiment, the center frame processing convolutional neural network may include a convolution operation, and a plurality of dilated convolution operations sequentially disposed and configured to receive a result of the convolution operation. A size of a kernel of the dilated convolution operation may be greater than a size of a kernel of the convolution operation.

In an embodiment, the kernel of the convolution operation may have a first value in a first row and a first column, a second value in the first row and a second column, a third value in the first row and a third column, a fourth value in the first row and a fourth column, a fifth value in the first row and a fifth column, a sixth value in a second row and the first column, a seventh value in the second row and the fifth column, an eighth value in a third row and the first column, a ninth value in the third row and the second column, a 10^{th} value in the third row and the third column, an 11^{th} value in the third row and the fourth column, and a 12^{th} value in the third row and the fifth column without having values in the second row and the second column, the second row and the third column, and the second row and the fourth column, which correspond to the center pixel group of the current frame.

In an embodiment, an impulse response of the convolution operation may have a first impulse value in a first row and a first column, a second impulse value in the first row and a second column, a third impulse value in the first row and a third column, a fourth impulse value in the first row and a fourth column, a fifth impulse value in the first row and a fifth column, a sixth impulse value in a second row and the first column, a seventh impulse value in the second row and the fifth column, an eighth impulse value in a third row and the first column, a ninth impulse value in the third row and the second column, a 10^{th} impulse value in the third row and the third column, an 11^{th} impulse value in the third row and the fourth column, and a 12^{th} impulse value in the third row and the fifth column without having impulse values in the second row and the second column, the second row and the third column, and the second row and the fourth column, which correspond to the center pixel group of the current frame.

In an embodiment, a kernel of a first dilated convolution operation may have a first value in a first row and a first column, a second value in the first row and a fourth column, a third value in the first row and a seventh column, a fourth value in a third row and the first column, a fifth value in the third row and the seventh column, a sixth value in a fifth row and the first column, a seventh value in the fifth row and the fourth column, and an eighth value in the fifth row and the seventh column without having values in the third row and a third column, the third row and the fourth column, and the third row and a fifth column, which correspond to the center pixel group of the current frame, and without having values in a second row, a fourth row, second to third columns, and fifth to sixth columns.

In an embodiment, an impulse response of the first dilated convolution operation may have impulse values in areas other than a fourth row and a fifth column, the fourth row and a sixth column, and the fourth row and a seventh column, which correspond to the center pixel group of the current frame, respectively, without having an impulse value in the fourth row and the fifth column, the fourth row and the sixth column, and the fourth row and the seventh column in a matrix having seven rows and 11 columns.

In an embodiment, the center frame processing convolutional neural network may include a first sequential path configured to receive the peripheral processing value, and sequentially perform a convolution operation and a second sequential path configured to receive the current frame, and sequentially perform a convolution operation.

In an embodiment, a number of convolution operation layers of the first sequential path may be less than a number of convolution operation layers of the second sequential path.

In an embodiment, the number of convolution operation layers of the first sequential path may be 3. The number of convolution operation layers of the second sequential path may be 5.

In an embodiment, a size of a kernel of the convolution operation of the first sequential path may be greater than a size of a kernel of the convolution operation of the second sequential path.

In an embodiment, the size of the kernel of the convolution operation of the first sequential path may be 5×5. The size of the kernel of the convolution operation of the second sequential path may be 3×3.

In an embodiment, the center frame processing convolutional neural network may include a first convolution operation layer configured to receive the peripheral processing value, and output a first convolution result, a second convolution operation layer configured to receive the first convolution result, and output a second convolution result, a third convolution operation layer configured to receive the second convolution result, and output a third convolution result, a fourth convolution operation layer configured to receive the current frame, and output a fourth convolution result, a fifth convolution operation layer configured to receive the fourth convolution result, and output a fifth convolution result, a sixth convolution operation layer configured to receive the fifth convolution result, and output a sixth convolution result, a seventh convolution operation layer configured to receive the sixth convolution result, and output a seventh convolution result and an eighth convolution operation layer configured to receive the seventh convolution result, and output an eighth convolution result.

In an embodiment, the center frame processing convolutional neural network may further include a ninth convolution operation layer configured to perform a 1×1 convolution operation and a ReLU operation on the first to eighth convolution results, which are concatenated.

In an embodiment, the first convolution result and an input of the center frame processing convolutional neural network on which a 1×1 convolution operation is performed may be input to the second convolution operation layer. The second convolution result and the input of the center frame processing convolutional neural network on which the 1×1 convolution operation is performed may be input to the third convolution operation layer. The fourth convolution result and the input of the center frame processing convolutional neural network on which the 1×1 convolution operation is performed may be input to the fifth convolution operation layer. The fifth convolution result and the input of the center frame processing convolutional neural network on which the 1×1 convolution operation is performed may be input to the sixth convolution operation layer. The sixth convolution result and the input of the center frame processing convolutional neural network on which the 1×1 convolution operation is performed may be input to the seventh convolution operation layer. The seventh convolution result and the input of the center frame processing convolutional neural network on which the 1×1 convolution operation is performed may be input to the eighth convolution operation layer.

In an embodiment, the information combining convolutional neural network may be configured to perform a 1×1 convolution operation on the center processing value and the peripheral processing value.

In an embodiment, i is a temporal index, k is a spatial index, L is a loss function, f_{θ} is a neural network parameterized by θ, y_{i,k} is a center pixel, Ω_{i,k} are adjacent pixels of the center pixel, excluding the center pixel, and x_{i,k} is correct data of the center pixel, a statistical prediction model used in the apparatus for removing the noise in the time-lapse image may be implemented by solving an optimization problem of

$$\begin{matrix}{θ}^{*} = arg {min}_{θ} {\sum }_{i , k} L ( {f}_{θ} ( {Ω}_{i , k} ) , {x}_{i , k} ) = \\ arg {min}_{θ} {\sum }_{i , k} L ( {f}_{θ} ( {Ω}_{i , k} ) , {y}_{i , k} ) .\end{matrix}$$

In an example apparatus for removing a noise in a time-lapse image according to the present inventive concept, the apparatus includes a center frame processing convolutional neural network, a peripheral frame processing convolutional neural network and an information combining convolutional neural network. The center frame processing convolutional neural network is configured to receive a current frame of an input image, and output a center processing value. The peripheral frame processing convolutional neural network is configured to receive a plurality of past frames adjacent to the current frame and a plurality of future frames adjacent to the current frame, and output a peripheral processing value. The information combining convolutional neural network is configured to calculate the center processing value and the peripheral processing value, and output an output image. A center value of a kernel of the center frame processing convolutional neural network corresponds to a center pixel of the current frame. The center value of the kernel is set to 0.

In an example method for removing a noise in a time-lapse image according to the present inventive concept, the method includes receiving a current frame of an input image, and generating a center processing value, receiving a plurality of past frames adjacent to the current frame and a plurality of future frames adjacent to the current frame, and generating a peripheral processing value and calculating the center processing value and the peripheral processing value, and outputting an output image. A center frame processing convolutional neural network configured to generate the center processing value does not refer to a center pixel of the current frame.

In an embodiment, the center frame processing convolutional neural network may be configured to further receive the peripheral processing value.

In an embodiment, a peripheral frame processing convolutional neural network configured to generate the peripheral processing value may refer to a center pixel of the past frame and a center pixel of the future frame.

In an embodiment, program instructions for executing the method for removing the noise in the time-lapse image may be stored on a non-transitory computer-readable storage medium.

### Effect of the Invention

According to an apparatus and a method for removing a noise in a time-lapse image of an embodiment of the present inventive concept as described above, the noise in the time-lapse image can be effectively removed, and time series information included in original image data can be restored.

In addition, the noise of the image can be removed without separate learning data even without assuming that signal components of adjacent frames in the time-lapse image are identical to each other.

In addition, information included in a current frame may be used as well as past and future frames, so that the noise can be well removed without distorting or removing the signal even in a case where a rapid change exists in the image data, a case where a capturing camera shakes, or the like.

### BRIEF EXPLANATION OF THE DRAWINGS

FIG. 1 is a view showing an example of noise removal according to the present embodiment.

FIG. 2A is a block diagram showing one example of an apparatus for removing a noise in a time-lapse image according to the present embodiment.

FIG. 2B is a block diagram showing one example of an apparatus for removing a noise in a time-lapse image according to the present embodiment.

FIGS. 3 and 4 are views showing dynamics indicators according to a time and a space.

FIG. 5 is a view showing one example of an apparatus for removing a noise in a time-lapse image according to the present embodiment.

FIG. 6 is a block diagram showing a center frame processing convolutional neural network of FIGS. 2A and 2B.

FIG. 7 is a view showing a kernel of a convolution operation of FIG. 6.

FIG. 8 is a view showing a kernel of a first dilated convolution operation of FIG. 6.

FIG. 9 is a view showing a kernel of a second dilated convolution operation of FIG. 6.

FIG. 10 is a view showing one example of an apparatus for removing a noise in a time-lapse image according to the present embodiment.

FIG. 11 is a block diagram showing a center frame processing convolutional neural network of the apparatus for removing the noise in the time-lapse image of FIG. 10.

FIG. 12 is a view showing a kernel of a convolution operation of FIG. 11.

FIG. 13 is a view showing a kernel of a first dilated convolution operation of FIG. 11.

FIG. 14 is a detailed block diagram showing one example of the apparatus for removing the noise in the time-lapse image of FIG. 2B.

FIG. 15 is a detailed block diagram showing one example of a peripheral frame processing convolutional neural network of FIG. 14.

FIG. 16 is a detailed block diagram showing one example of a center frame processing convolutional neural network of FIG. 14.

FIG. 17 is a view showing an impulse response of the center frame processing convolutional neural network of FIG. 14.

FIG. 18 is a view showing a noise removal result according to the present embodiment.

FIG. 19 is a view showing a noise removal result according to the present embodiment.

FIG. 20 is a view showing a noise removal result according to the present embodiment.

FIG. 21 is a view showing a noise removal result according to the present embodiment.

### DETAILED DESCRIPTION FOR CARRYING OUT THE INVENTION

The present inventive concept now will be described more fully hereinafter with reference to the accompanying drawings, in which exemplary embodiments of the present invention are shown. The present inventive concept may, however, be embodied in many different forms and should not be construed as limited to the exemplary embodiments set forth herein.

Rather, these exemplary embodiments are provided so that this disclosure will be thorough and complete, and will fully convey the scope of the present invention to those skilled in the art.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the inventive concept as used herein.

Hereinafter, preferred embodiments of the present inventive concept will be explained in detail with reference to the accompanying drawings. The same reference numerals are used for the same elements in the drawings, and duplicate explanations for the same elements may be omitted.

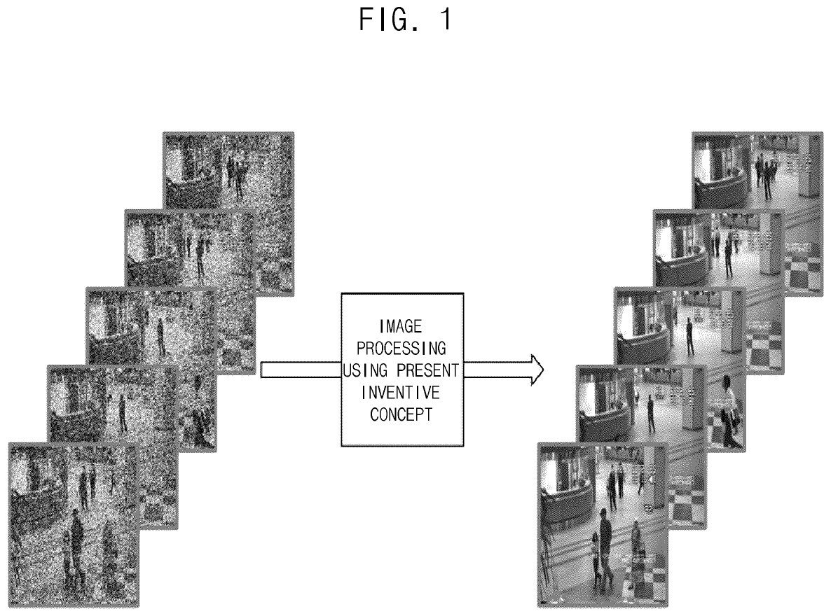

FIG. 1 is a view showing an example of noise removal according to the present embodiment.

A time-lapse image may refer to data obtained by continuously capturing the same location or the same object at regular time intervals, which is captured to observe a change in the object over time.

When an environment in which time-lapse image is captured has a low-illuminance condition, the capturing has to be performed very rapidly, or a capturing device that is used has poor noise performance, a very noisy image may be captured.

FIG. 1 shows input images and output images of an apparatus and a method for removing a noise in a time-lapse image according to the present embodiment. An output image from which a noise is removed may be obtained from an input image including the noise through an apparatus for removing a noise in a time-lapse image.

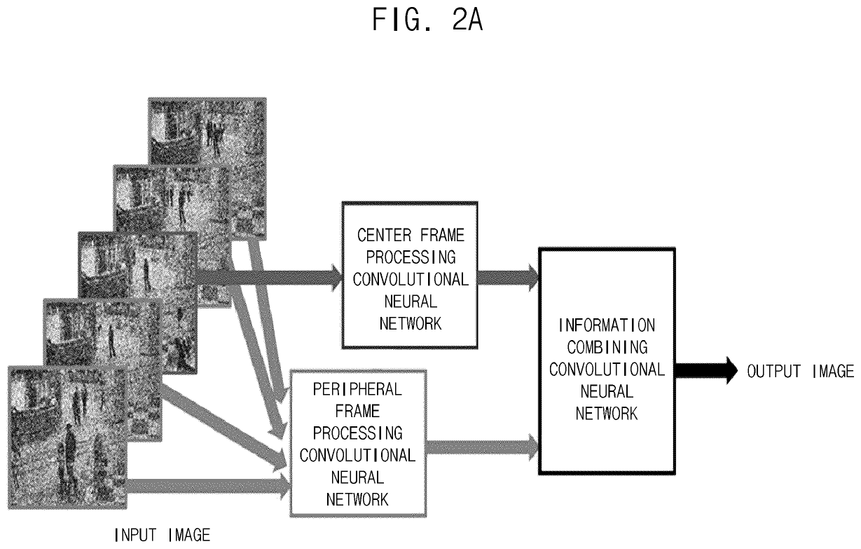

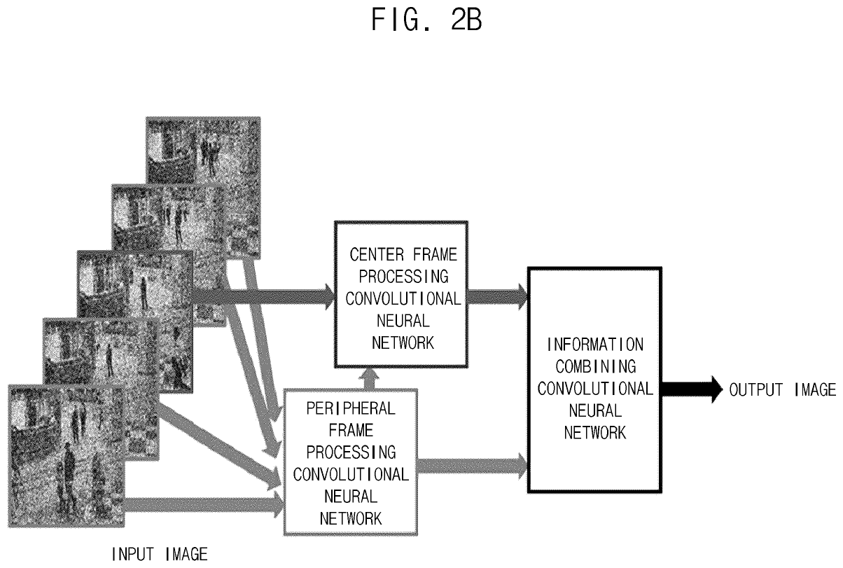

FIG. 2A is a block diagram showing one example of an apparatus for removing a noise in a time-lapse image according to the present embodiment.

Referring to FIG. 2A, according to the present inventive concept, there may be provided: (1) a convolutional neural network configured to receive a pixel value of a peripheral area of a three-dimensional (or n-dimensional) tensor based on each pixel as an input without receiving a center pixel value as an input for given image data (tensor); (2) an update of a convolutional parameter of the neural network through backpropagation; and (3) a method for inferring each pixel value in the image data.

An apparatus for removing a noise in a time-lapse image may include a center frame processing convolutional neural network, a peripheral frame processing convolutional neural network, and an information combining convolutional neural network. The center frame processing convolutional neural network may receive a current frame of an input image, and output a center processing value. The peripheral frame processing convolutional neural network may receive a plurality of past frames adjacent to the current frame and a plurality of future frames adjacent to the current frame, and output a peripheral processing value. The information combining convolutional neural network may calculate the center processing value and the peripheral processing value, and output an output image. The center frame processing convolutional neural network may not refer to a center pixel of the current frame.

For example, a center value of a kernel of the center frame processing convolutional neural network may correspond to the center pixel of the current frame, and the center value of the kernel may be set to 0.

Meanwhile, the peripheral frame processing convolutional neural network may refer to a center pixel of the past frame and a center pixel of the future frame.

The information combining convolutional neural network may perform a 1×1 convolution operation on the center processing value and the peripheral processing value. When i is a temporal index, k is a spatial index, L is a loss function, f_{θ} is a neural network parameterized by θ, y_{i,k} is a center pixel, Ω_{i,k} are adjacent pixels of the center pixel, excluding the center pixel, and x_{i,k} is correct data of the center pixel, a statistical prediction model used in the apparatus for removing the noise in the time-lapse image may be implemented by solving an optimization problem of

$$\begin{matrix}{θ}^{*} = arg {min}_{θ} {\sum }_{i , k} L ( {f}_{θ} ( {Ω}_{i , k} ) , {x}_{i , k} ) = \\ arg {min}_{θ} {\sum }_{i , k} L ( {f}_{θ} ( {Ω}_{i , k} ) , {y}_{i , k} ) .\end{matrix}$$

According to the present inventive concept, the noise of the image may be removed without separate learning data even without assuming that signal components of adjacent frames in the time-lapse image are identical to each other.

According to existing methods, in order to train a neural network configured to remove a noise from time-lapse image data, past and future frames are used as inputs for inferring a current frame from which the noise is removed. This is not a problem when a change in the image data is slow as compared with a capturing speed, whereas a signal as well as the noise may be removed together with the noise when a rapid change exists in a specific frame. In contrast, according to the present inventive concept, information included in the current frame as well as the past and future frames may be used together with the past and future frames, so that the noise may be well removed without distorting or removing a signal even in a case where a rapid change exists in the image data.

FIG. 2B is a block diagram showing one example of an apparatus for removing a noise in a time-lapse image according to the present embodiment.

Referring to FIG. 2B, an apparatus for removing a noise in a time-lapse image may include a center frame processing convolutional neural network, a peripheral frame processing convolutional neural network, and an information combining convolutional neural network. The center frame processing convolutional neural network may receive a current frame of an input image and a peripheral processing value, and output a center processing value. The peripheral frame processing convolutional neural network may receive a plurality of past frames adjacent to the current frame and a plurality of future frames adjacent to the current frame, and output the peripheral processing value. The information combining convolutional neural network may calculate the center processing value and the peripheral processing value, and output an output image. The center frame processing convolutional neural network may not refer to a center pixel of the current frame.

A method for removing a noise in a time-lapse image may include: receiving a current frame of an input image, and generating a center processing value; receiving a plurality of past frames adjacent to the current frame and a plurality of future frames adjacent to the current frame, and generating a peripheral processing value; and calculating the center processing value and the peripheral processing value, and outputting an output image. A center frame processing convolutional neural network configured to generate the center processing value may not refer to a center pixel of the current frame.

For example, a center value of a kernel of the center frame processing convolutional neural network may correspond to the center pixel of the current frame, and the center value of the kernel may be set to 0.

Unlike the embodiment of FIG. 2A, according to the embodiment of FIG. 2B, the center frame processing convolutional neural network may further receive the peripheral processing value. When the center frame processing convolutional neural network receives the current frame and the peripheral processing value as inputs, the peripheral processing value may be referred to while generating the center processing value corresponding to the current frame, so that noise removal performance may be improved.

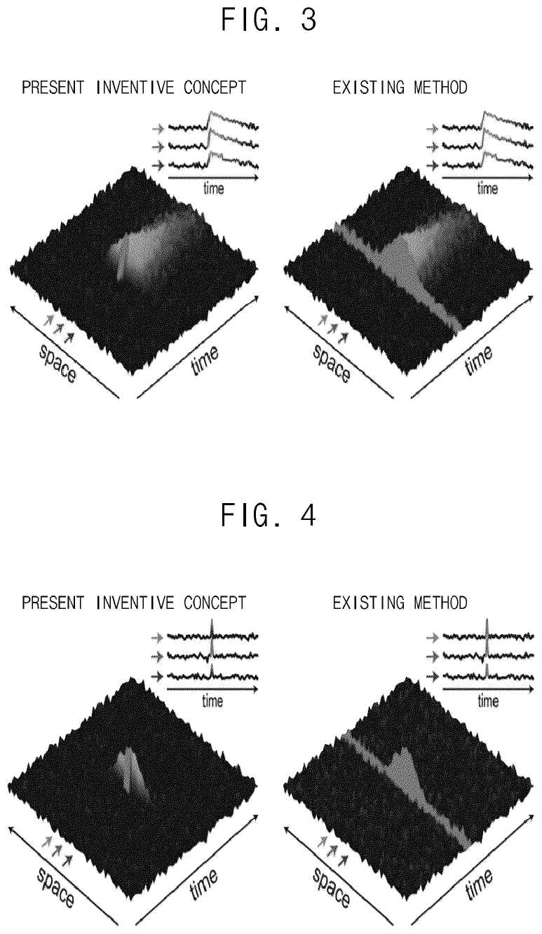

FIGS. 3 and 4 are views showing dynamics indicators according to a time and a space.

FIG. 3 shows dynamics indicators in a self-supervised learning system according to the present inventive concept and an existing method when a change in the image over time is slow, and FIG. 4 shows dynamics indicators in the self-supervised learning system according to the present inventive concept and the existing method when the change in the image over time is fast. In this case, the existing method may be a method that uses frames that are temporally adjacent to a current frame to remove a noise from the current frame of image data.

In FIGS. 3 and 4, a portion displayed on a specific time plane may represent a prediction target area, and a portion extending behind the specific time plane may represent a receptive field.

As shown in FIG. 4, in a case where a significant change exists in only one frame within the image data, information of the frame may be lost so as not to be recovered when the existing noise removal method is used, whereas spatial peripheral pixel information of a pixel from which a noise is to be removed may be used so that the noise is removed without losing the information when the present inventive concept is used.

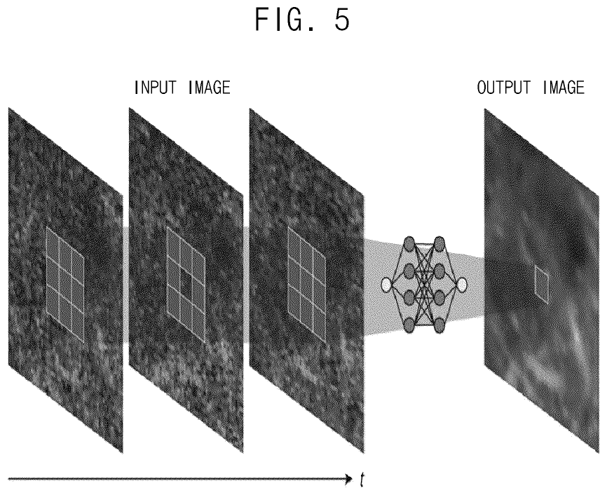

FIG. 5 is a view showing one example of an apparatus for removing a noise in a time-lapse image according to the present embodiment.

Referring to FIG. 5, in order to actually implement an apparatus capable of removing a noise without losing information by using spatial peripheral pixel information of a pixel from which the noise is to be removed, the present inventive concept proposes and utilizes a convolutional neural network structure that does not receive a center value (meaning a middle value of a tensor, not a median) within a three-dimensional or n-dimensional tensor as an input.

A first frame of the input image may represent the past frame, a second frame of the input image may represent the current frame, and a third frame of the input image may represent the future frame. Although one past frame and one future frame have been shown in FIG. 5 for convenience of description, the present inventive concept is not limited thereto. A plurality of past frames and a plurality of future frames may be used for the noise removal.

As shown in FIG. 5, the center frame processing convolutional neural network may not refer to the center pixel of the current frame. In other words, the center value of the kernel of the center frame processing convolutional neural network may be set to 0.

Meanwhile, the peripheral frame processing convolutional neural network may refer to the center pixel of the past frame and the center pixel of the future frame. In other words, a center value of a kernel of the peripheral frame processing convolutional neural network may have a value that is not 0.

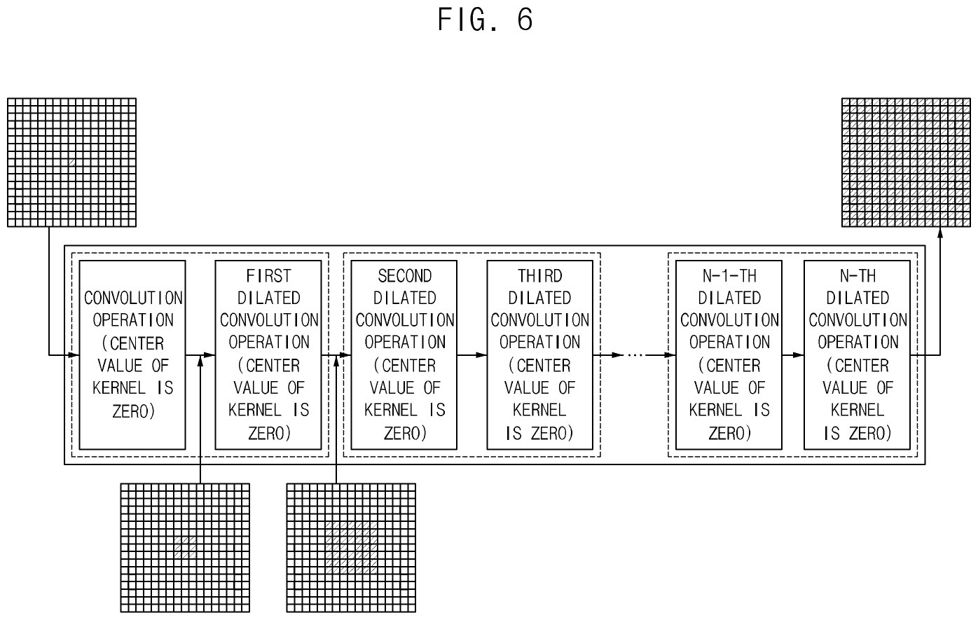

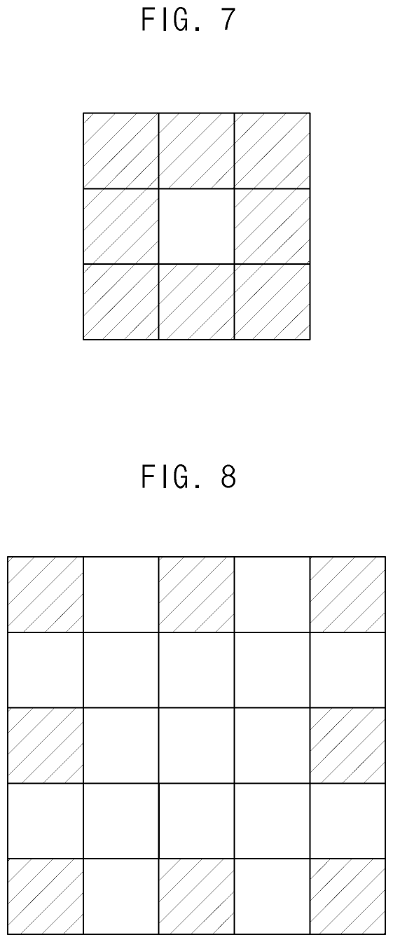

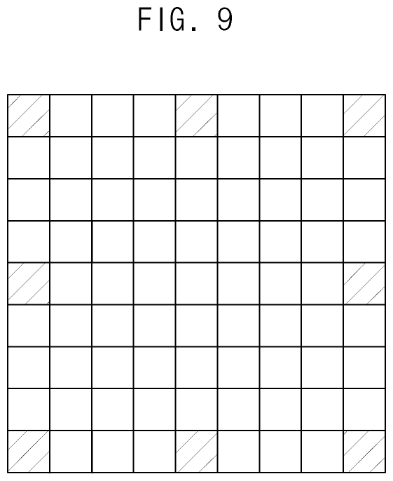

FIG. 6 is a block diagram showing a center frame processing convolutional neural network of FIGS. 2A and 2B. FIG. 7 is a view showing a kernel of a convolution operation of FIG. 6. FIG. 8 is a view showing a kernel of a first dilated convolution operation of FIG. 6. FIG. 9 is a view showing a kernel of a second dilated convolution operation of FIG. 6.

Referring to FIGS. 1 to 9, of a center frame (current frame) of time-lapse image data may prevent a pixel value at the same location as in an input frame (current frame) from being referred to while each pixel value is inferred.

To this end, the center frame processing neural network may be configured as shown in FIG. 6. Input data may pass through a convolution layer and dilated convolution layers that are repeated. In this case, center values of both kernels of convolution and dilated convolution may be initialized to 0, and may not be updated. Accordingly, each pixel of the input data may affect only pixels excluding a pixel that is present at the same location as in output data.

As shown in a rightmost picture of FIG. 6, an impulse response of the center frame processing convolutional neural network may have an impulse value for an impulse area having a predetermined size, which surrounds the center pixel of the current frame, without having a center impulse value corresponding to the center pixel of the current frame. The impulse area may be an entire pixel area of the input image. Alternatively, the impulse area may be greater or less than the entire pixel area of the input image.

The center frame processing convolutional neural network may include a convolution operation, and a plurality of dilated convolution operations sequentially disposed and configured to receive a result of the convolution operation. A size of a kernel of the dilated convolution operation may be greater than a size of a kernel of the convolution operation.

As shown in FIG. 7, the kernel of the convolution operation may have a first value in a first row and a first column, a second value in the first row and a second column, a third value in the first row and a third column, a fourth value in a second row and the first column, a fifth value in the second row and the third column, a sixth value in a third row and the first column, a seventh value in the third row and the second column, and an eighth value in the third row and the third column without having a value in the second row and the second column corresponding to the center pixel of the current frame.

As shown in a bottom picture of FIG. 6, an impulse response of the convolution operation, which is generated through the kernel of the convolution operation, may have a first impulse value in a first row and a first column, a second impulse value in the first row and a second column, a third impulse value in the first row and a third column, a fourth impulse value in a second row and the first column, a fifth impulse value in the second row and the third column, a sixth impulse value in a third row and the first column, a seventh impulse value in the third row and the second column, and an eighth impulse value in the third row and the third column without having an impulse value in the second row and the second column corresponding to the center pixel of the current frame.

As shown in FIG. 8, a kernel of a first dilated convolution operation may have a first value in a first row and a first column, a second value in the first row and a third column, a third value in the first row and a fifth column, a fourth value in a third row and the first column, a fifth value in the third row and the fifth column, a sixth value in a fifth row and the first column, a seventh value in the fifth row and the third column, and an eighth value in the fifth row and the fifth column without having a value in the third row and the third column corresponding to the center pixel of the current frame, and without having values in a second row, a fourth row, a second column, and a fourth column.

As shown in the bottom picture of FIG. 6, an impulse response of the first dilated convolution operation, which is generated through the kernel of the first dilated convolution operation, may have impulse values in areas other than a fourth row and a fourth column corresponding to the center pixel of the current frame, respectively, without having an impulse value in the fourth row and the fourth column in a matrix having seven rows and seven columns.

When the kernel of the first dilated convolution operation of FIG. 7 is applied to the impulse response of the convolution operation, an impulse response of the first dilated convolution operation, which prevents the fourth row and the fourth column corresponding to the center pixel from having an impulse value, may be generated.

In addition, as shown in FIG. 9, a kernel of a second dilated convolution operation may have a first value in a first row and a first column, a second value in the first row and a fifth column, a third value in the first row and a ninth column, a fourth value in a fifth row and the first column, a fifth value in the fifth row and the ninth column, a sixth value in a ninth row and the first column, a seventh value in the ninth row and the fifth column, and an eighth value in the ninth row and the ninth column without having a value in the fifth row and the fifth column corresponding to the center pixel of the current frame, and without having values in second to fourth rows, sixth to eighth rows, second to fourth columns, and sixth to eighth columns.

When the kernel of the second dilated convolution operation of FIG. 9 is applied to the impulse response of the first dilated convolution operation, an impulse response having a dilated impulse area still without having an impulse value for the center pixel may be generated.

In this way, the size of the kernel may gradually become larger as the dilated convolution operation is repeatedly performed, so that an impulse response having a gradually dilated impulse area without having an impulse value for the center pixel may be generated.

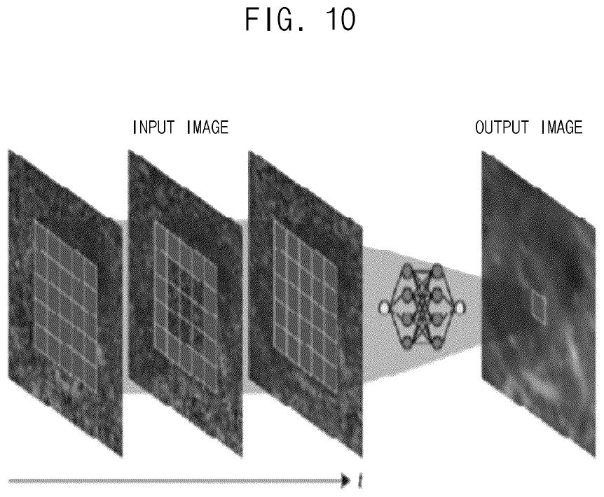

FIG. 10 is a view showing one example of an apparatus for removing a noise in a time-lapse image according to the present embodiment.

An apparatus for removing a noise in a time-lapse image of FIG. 10 may be identical to the apparatus for removing the noise in the time-lapse image of FIG. 5 except that the center frame processing convolutional neural network does not refer to a center pixel group including one center pixel and a plurality of peripheral pixels adjacent to the center pixel, instead of one center pixel.

As shown in FIG. 10, the center frame processing convolutional neural network may not refer to a center pixel group of the current frame, which includes the center pixel of the current frame and a plurality of peripheral pixels adjacent to the center pixel. In other words, values corresponding to the center pixel group in the kernel of the center frame processing convolutional neural network may be set to 0.

Although the center pixel group has been illustrated in FIG. 10 as including nine pixels in three rows and three columns, the present inventive concept is not limited thereto.

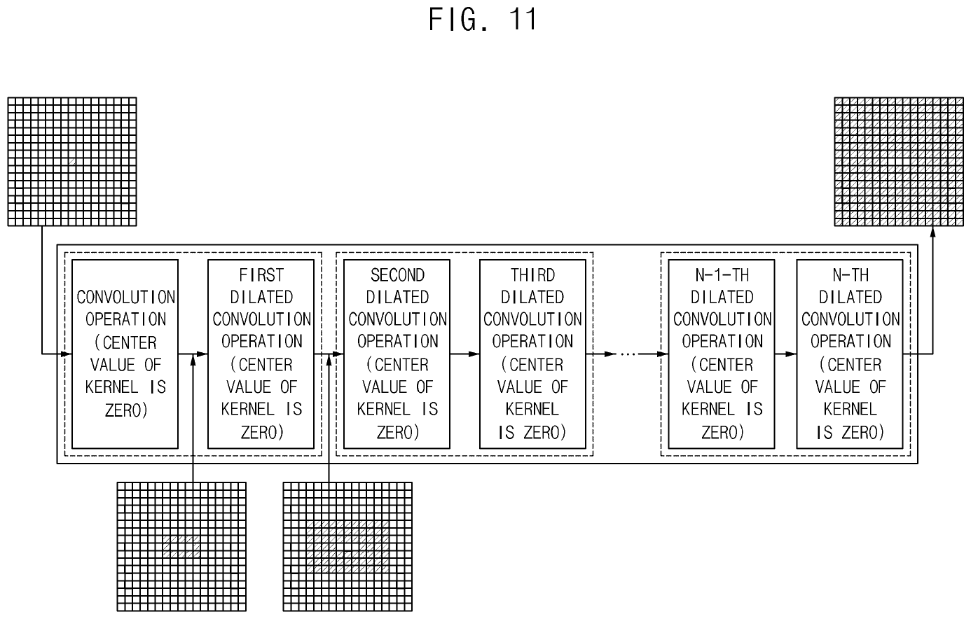

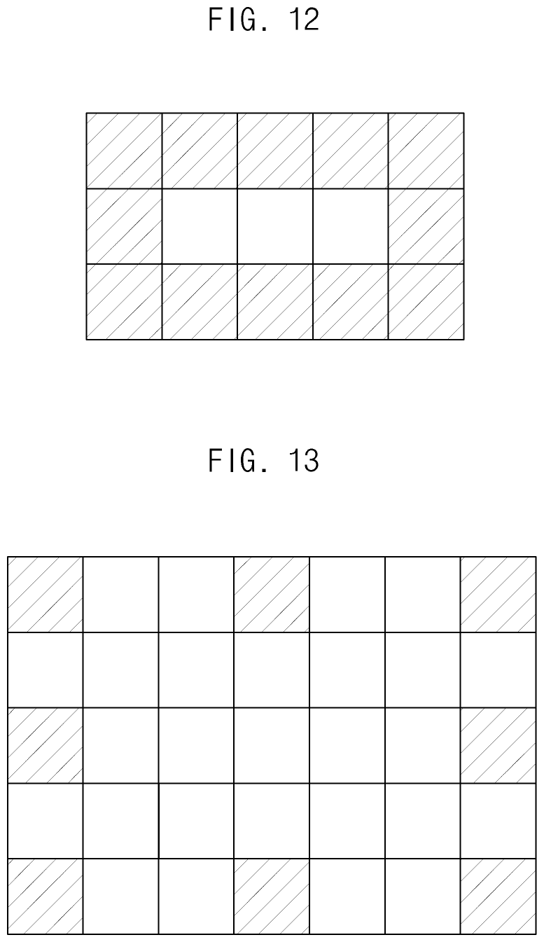

FIG. 11 is a block diagram showing a center frame processing convolutional neural network of the apparatus for removing the noise in the time-lapse image of FIG. 10. FIG. 12 is a view showing a kernel of a convolution operation of FIG. 11. FIG. 13 is a view showing a kernel of a first dilated convolution operation of FIG. 11.

A center frame processing convolutional neural network of FIGS. 11 to 13 may be identical to the center frame processing convolutional neural network of FIGS. 6 to 9 except that the center frame processing convolutional neural network does not refer to a center pixel group including one center pixel and a plurality of peripheral pixels adjacent to the center pixel, instead of one center pixel

FIGS. 11 to 13 illustrate that the center pixel group includes three pixels in one row and three columns.

Referring to FIGS. 1 to 4 and FIGS. 10 to 13, the center frame processing neural network may be configured as shown in FIG. 11. Input data may pass through a convolution layer and dilated convolution layers that are repeated. In this case, center values of both kernels of convolution and dilated convolution in one row and three columns may be initialized to 0, and may not be updated.

As shown in a rightmost picture of FIG. 11, an impulse response of the center frame processing convolutional neural network may have an impulse value for an impulse area having a predetermined size, which surrounds the center pixel group of the current frame, without having an impulse value corresponding to the center pixel group including the center pixel of the current frame and left and right pixels of the center pixel. The impulse area may be an entire pixel area of the input image. Alternatively, the impulse area may be greater or less than the entire pixel area of the input image.

The center frame processing convolutional neural network may include a convolution operation, and a plurality of dilated convolution operations sequentially disposed and configured to receive a result of the convolution operation. A size of a kernel of the dilated convolution operation may be greater than a size of a kernel of the convolution operation.

As shown in FIG. 12, the kernel of the convolution operation may have a first value in a first row and a first column, a second value in the first row and a second column, a third value in the first row and a third column, a fourth value in the first row and a fourth column, a fifth value in the first row and a fifth column, a sixth value in a second row and the first column, a seventh value in the second row and the fifth column, an eighth value in a third row and the first column, a ninth value in the third row and the second column, a 10th value in the third row and the third column, an 11th value in the third row and the fourth column, and a 12th value in the third row and the fifth column without having values in the second row and the second column, the second row and the third column, and the second row and the fourth column, which correspond to the center pixel group of the current frame.

As shown in a bottom picture of FIG. 11, an impulse response of the convolution operation, which is generated through the kernel of the convolution operation, may have a first impulse value in a first row and a first column, a second impulse value in the first row and a second column, a third impulse value in the first row and a third column, a fourth impulse value in the first row and a fourth column, a fifth impulse value in the first row and a fifth column, a sixth impulse value in a second row and the first column, a seventh impulse value in the second row and the fifth column, an eighth impulse value in a third row and the first column, a ninth impulse value in the third row and the second column, a 10th impulse value in the third row and the third column, an 11th impulse value in the third row and the fourth column, and a 12th impulse value in the third row and the fifth column without having impulse values in the second row and the second column, the second row and the third column, and the second row and the fourth column, which correspond to the center pixel group of the current frame.

As shown in FIG. 13, a kernel of a first dilated convolution operation may have a first value in a first row and a first column, a second value in the first row and a fourth column, a third value in the first row and a seventh column, a fourth value in a third row and the first column, a fifth value in the third row and the seventh column, a sixth value in a fifth row and the first column, a seventh value in the fifth row and the fourth column, and an eighth value in the fifth row and the seventh column without having values in the third row and a third column, the third row and the fourth column, and the third row and a fifth column, which correspond to the center pixel group of the current frame, and without having values in a second row, a fourth row, second to third columns, and fifth to sixth columns

As shown in the bottom picture of FIG. 11, an impulse response of the first dilated convolution operation, which is generated through the kernel of the first expansion convolution operation, may have impulse values in areas other than a fourth row and a fifth column, the fourth row and a sixth column, and the fourth row and a seventh column, which correspond to the center pixel group of the current frame, respectively, without having an impulse value in the fourth row and the fifth column, the fourth row and the sixth column, and the fourth row and the seventh column in a matrix having seven rows and 11 columns.

When the kernel of the first dilated convolution operation of FIG. 13 is applied to the impulse response of the convolution operation, an impulse response of the first dilated convolution operation, which prevents the fourth row and the fifth column, the fourth row and the sixth column, and the fourth row and the seventh column corresponding to the center pixel group from having impulse values, may be generated.

In this way, the size of the kernel may gradually become larger as the dilated convolution operation is repeatedly performed, so that an impulse response having a gradually dilated impulse area without having an impulse value for the center pixel group may be generated.

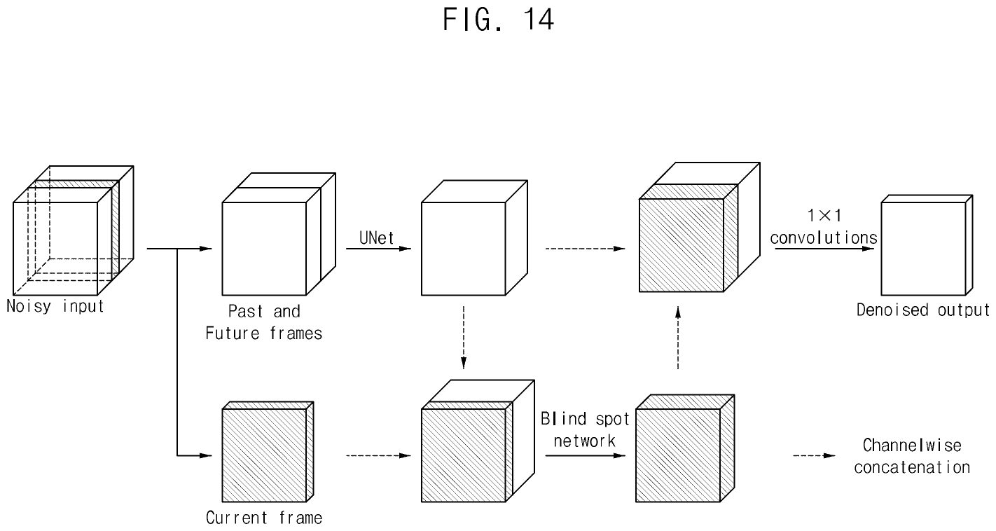

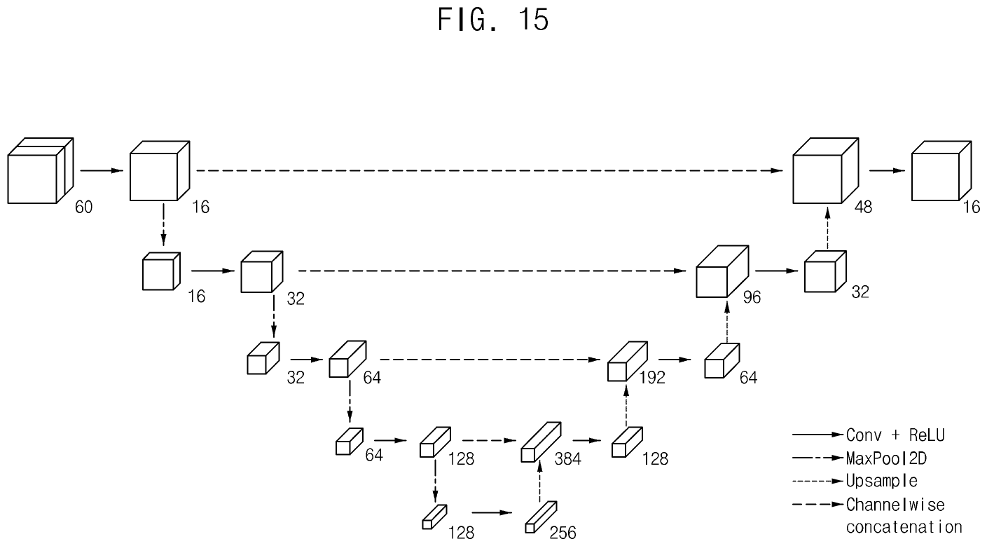

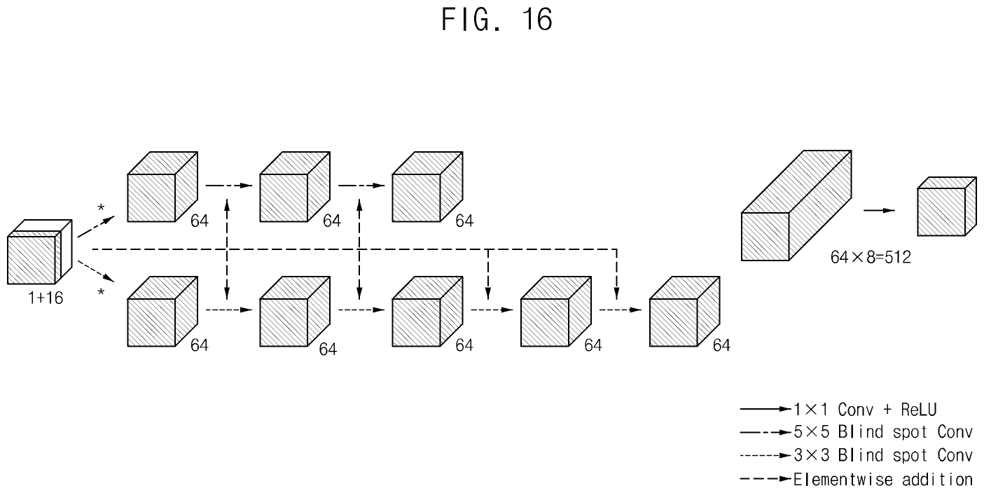

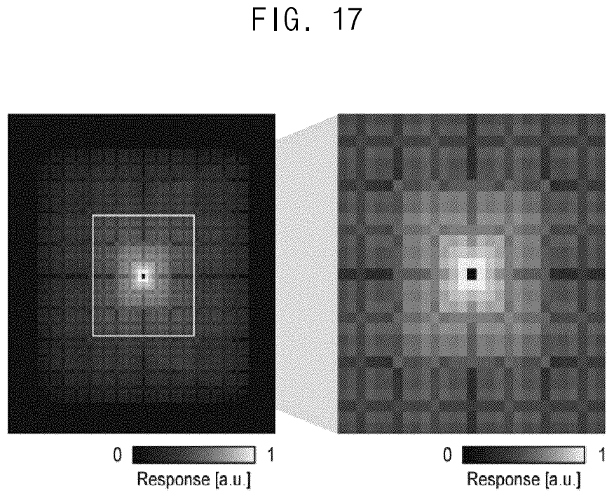

FIG. 14 is a detailed block diagram showing one example of the apparatus for removing the noise in the time-lapse image of FIG. 2B. FIG. 15 is a detailed block diagram showing one example of a peripheral frame processing convolutional neural network of FIG. 14. FIG. 16 is a detailed block diagram showing one example of a center frame processing convolutional neural network of FIG. 14. FIG. 17 is a view showing an impulse response of the center frame processing convolutional neural network of FIG. 14.

Referring to FIGS. 1 to 17, the peripheral frame processing neural network may use a general convolutional neural network structure (e.g., U-Net). In addition, an output of the peripheral frame processing neural network may be concatenated with the center frame and given as an input to the center frame processing neural network.

An output of the center frame processing neural network and the output of the peripheral frame processing neural network may be concatenated and input to the information combining convolutional neural network with a convolution kernel having a size of 1×1.

The loss function may be calculated by comparing a final output of the neural network with the current frame. A measure of a distance between two tensors may be used as the loss function, and an L1-distance or an L2-distance may be used.

The neural network may be trained by repeatedly performing a process of updating a parameter within the neural network to minimize the loss function described above.

When the training of the neural network is completed, a tensor in which past and future frames are concatenated based on a target frame from which a noise is to be removed may be given to the neural network as an input, and a result may be obtained. The above process may be repeatedly performed for a plurality of frames, so that the noise in the time-lapse image may be removed.

FIG. 14 shows one example of an overall convolutional neural network structure. FIG. 15 shows one example of a peripheral frame processing convolutional neural network, and FIG. 16 shows one example of a center frame processing convolutional neural network.

In FIG. 14, Blind spot Network may represent a network that does not refer to a center pixel of a current frame, and in FIG. 16, Blind spot Conv may represent a convolution operation that does not refer to a center pixel of a current frame.

Referring to FIG. 16, the center frame processing convolutional neural network may include: a first sequential path configured to receive the peripheral processing value, and sequentially perform a convolution operation; and a second sequential path configured to receive the current frame, and sequentially perform a convolution operation.

The number of convolution operation layers of the first sequential path may be less than the number of convolution operation layers of the second sequential path. For example, the number of convolution operation layers of the first sequential path may be 3, and the number of convolution operation layers of the second sequential path may be 5.

A size of a kernel of the convolution operation of the first sequential path may be greater than a size of a kernel of the convolution operation of the second sequential path. For example, the size of the kernel of the convolution operation of the first sequential path may be 5×5, and the size of the kernel of the convolution operation of the second sequential path may be 3×3.

The first sequential path may include: a first convolution operation layer configured to receive the peripheral processing value, and output a first convolution result; a second convolution operation layer configured to receive the first convolution result, and output a second convolution result; and a third convolution operation layer configured to receive the second convolution result, and output a third convolution result.

The second sequential path may include: a fourth convolution operation layer configured to receive the current frame, and output a fourth convolution result; a fifth convolution operation layer configured to receive the fourth convolution result, and output a fifth convolution result; a sixth convolution operation layer configured to receive the fifth convolution result, and output a sixth convolution result; a seventh convolution operation layer configured to receive the sixth convolution result, and output a seventh convolution result; and an eighth convolution operation layer configured to receive the seventh convolution result, and output an eighth convolution result.

The center frame processing convolutional neural network may further include a ninth convolution operation layer configured to perform a 1×1 convolution operation and a ReLU operation on the first to eighth convolution results, which are concatenated.

In addition, the center frame processing convolutional neural network may include a shortcut connection. In other words, the first convolution result and an input of the center frame processing convolutional neural network on which a 1×1 convolution operation is performed may be input to the second convolution operation layer. The second convolution result and the input of the center frame processing convolutional neural network on which the 1×1 convolution operation is performed may be input to the third convolution operation layer. The fourth convolution result and the input of the center frame processing convolutional neural network on which the 1×1 convolution operation is performed may be input to the fifth convolution operation layer. The fifth convolution result and the input of the center frame processing convolutional neural network on which the 1×1 convolution operation is performed may be input to the sixth convolution operation layer. The sixth convolution result and the input of the center frame processing convolutional neural network on which the 1×1 convolution operation is performed may be input to the seventh convolution operation layer. The seventh convolution result and the input of the center frame processing convolutional neural network on which the 1×1 convolution operation is performed may be input to the eighth convolution operation layer.

When the center frame processing neural network is designed as shown in FIG. 16, the center frame processing neural network may have an impulse response as shown in FIG. 17. A right picture of FIG. 17 is an enlarged view of a center portion of a left picture of FIG. 17.

Referring to FIG. 17, since the center value of the impulse response is 0, each pixel in the input image may not affect a pixel that is present at the same location as in the output image.

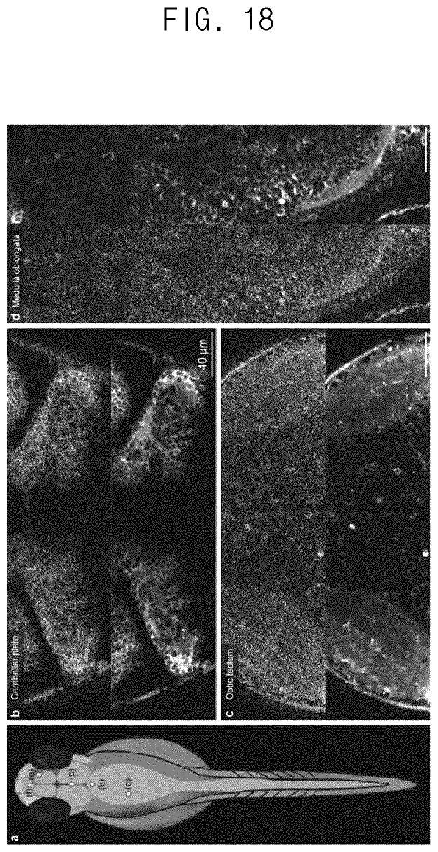

FIG. 18 is a view showing a noise removal result according to the present embodiment.

In this case, a in FIG. 18 shows a larval zebrafish (small fish) expressing a GCaMP7a calcium indicator under the control of a huc promoter. An upper portion of b in FIG. 18 shows raw data including a noise, and a lower portion of b in FIG. 18 shows a noise removal result according to the present inventive concept. An upper portion of c in FIG. 18 shows raw data including a noise, and a lower portion of c in FIG. 18 shows a noise removal result according to the present inventive concept. A left portion of d in FIG. 18 shows raw data including a noise, and a right portion of d in FIG. 18 shows a noise removal result according to the present inventive concept.

Referring to FIG. 18, it was found that a noise in a time-lapse image of a brain of a zebrafish (small fish) may be removed very effectively through the present inventive concept.

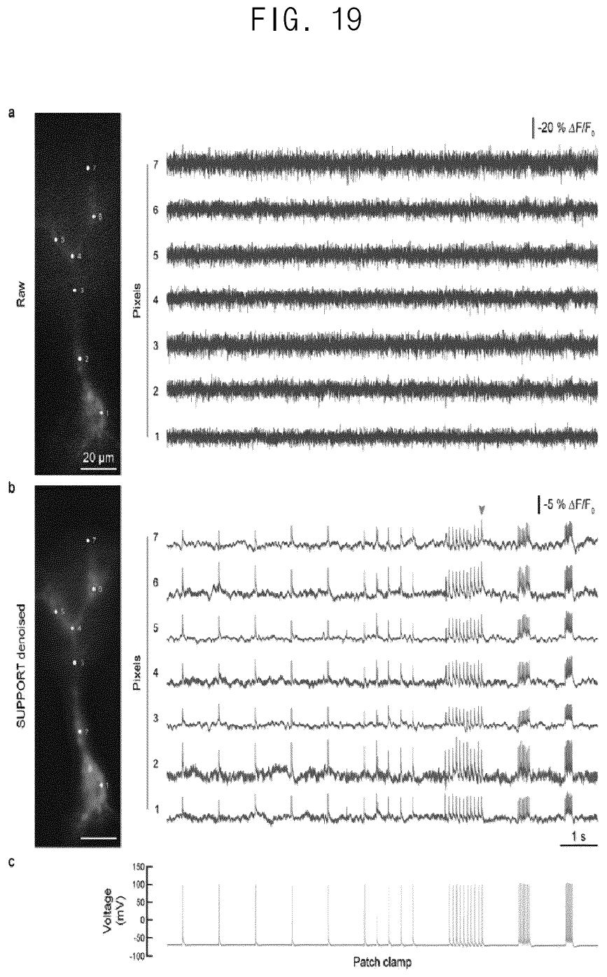

FIG. 19 is a view showing a noise removal result according to the present embodiment.

FIG. 19 shows a voltage signal along an axonal branch. In this case, a in FIG. 19 shows raw data (Raw), and b in FIG. 19 shows a noise removal result (SUPPORT denoised) according to the present inventive concept. In addition, c in FIG. 19c shows voltage traces from the corresponding electrophysiological recording.

Referring to FIG. 19, it was found that a noise in a voltage imaging image may be removed very effectively through the present inventive concept. Since a brightness of each cell in voltage imaging data is rapidly changed in milliseconds, a signal has been removed together with the noise when using existing methods, whereas the signal may be preserved when the noise is removed through the present inventive concept.

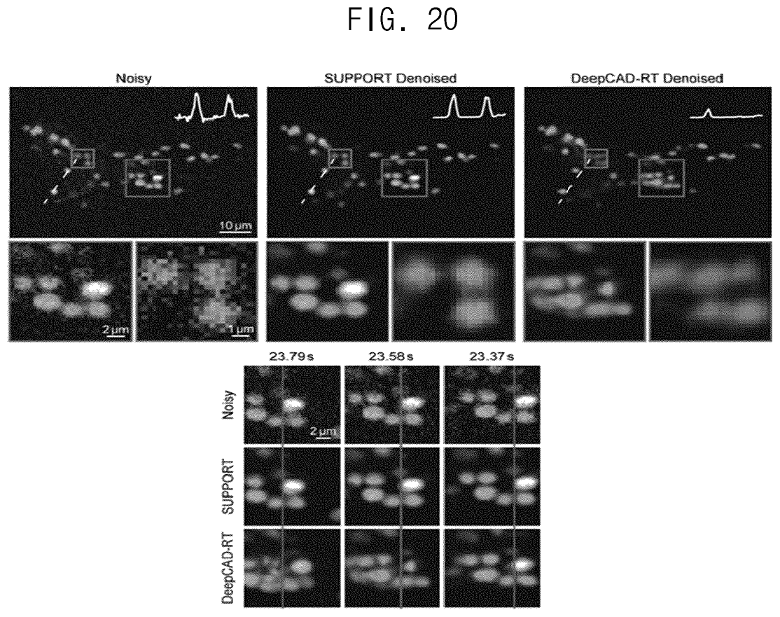

FIG. 20 is a view showing a noise removal result according to the present embodiment.

In FIG. 20, Noisy may represent raw data including a noise, SUPPORT Denoised may represent a noise removal result according to the present inventive concept, and DeepCAD-RT Denoised may represent a noise removal result according to a conventional method for performing noise removal by referring only to past and future frames without referring to a current frame.

Referring to FIG. 20, it was found that a noise in a type-lapse image of moving Caenorhabditis elegans (small annelid) may be removed very effectively through the present inventive concept. Since Caenorhabditis elegans moves rapidly to cause a great change in a signal for each adjacent frame, the noise may be removed without distortion of the signal when the noise is removed through the present inventive concept as compared with a case where a plurality of artifacts have occurred in the image when the noise is removed by using the existing method.

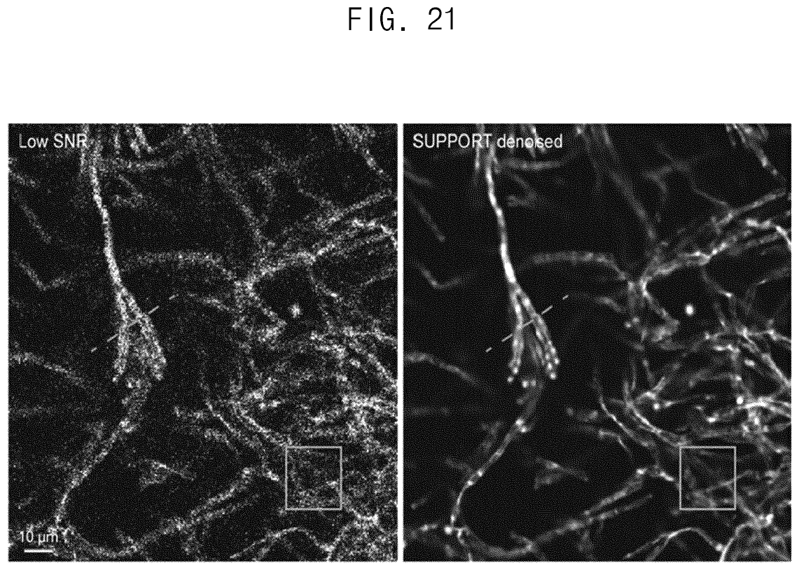

FIG. 21 is a view showing a noise removal result according to the present embodiment.

In FIG. 21, Low SNR may represent an image with a low signal-to-noise ratio of an axial slice of Penicillium, and SUPPORT denoised may represent a noise removal result of the axial slice of Penicillium according to the present inventive concept.

Referring to FIG. 21, it was found that a noise is well removed even when the noise is removed by considering a three-dimensional microscopy image obtained through a plurality of tomography scans as a time-lapse image.

According to the present embodiment, the noise in the time-lapse image can be effectively removed, and time series information included in original image data can be restored.

In addition, the noise of the image can be removed without separate learning data even without assuming that signal components of adjacent frames in the time-lapse image are identical to each other.

In addition, information included in a current frame may be used as well as past and future frames, so that the noise can be well removed without distorting or removing the signal even in a case where a rapid change exists in the image data, a case where a capturing camera shakes, or the like.

In an embodiment of the present inventive concept, the method for removing the noise in the time-lapse image may be operated by a computing apparatus.

According to an embodiment of the present inventive concept, a non-transitory computer-readable storage medium having stored thereon program instructions of the method for removing the noise in the time-lapse image may be provided. The above mentioned method may be written as a program executed on the computer. The method may be implemented in a general purpose digital computer which operates the program using a computer-readable medium. In addition, the structure of the data used in the above mentioned method may be written on a computer readable medium through various means. The computer readable medium may include program instructions, data files and data structures alone or in combination. The program instructions written on the medium may be specially designed and configured for the present inventive concept, or may be generally known to a person skilled in the computer software field. For example, the computer readable medium may include a magnetic medium such as a hard disk, a floppy disk and a magnetic tape, an optical recording medium such as CD-ROM and DVD, a magneto-optical medium such as floptic disc and a hardware device specially configured to store and execute the program instructions such as ROM, RAM and a flash memory. For example, the program instructions may include a machine language codes produced by a compiler and high-level language codes which may be executed by a computer using an interpreter or the like. The hardware device may be configured to operate as one or more software modules to perform the operations of the present inventive concept.

In addition, the above mentioned method for removing the noise in the time-lapse image may be implemented in a form of a computer-executed computer program or an application which are stored in a storage method.

### INDUSTRIAL AVAILABILITY

According to the present inventive concept, the noise in the time-lapse image can be effectively removed, and time series information included in original image data can be restored. In addition, the noise of the image can be removed without separate learning data even without assuming that signal components of adjacent frames in the time-lapse image are identical to each other. In addition, information included in a current frame may be used as well as past and future frames, so that the noise can be well removed without distorting or removing the signal even in a case where a rapid change exists in the image data, a case where a capturing camera shakes, or the like.

Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims.

What is claimed is:

1. An apparatus for removing a noise in a time-lapse image, the apparatus comprising:
a center frame processing convolutional neural network configured to receive a current frame of an input image, and output a center processing value;
a peripheral frame processing convolutional neural network configured to receive a plurality of past frames adjacent to the current frame and a plurality of future frames adjacent to the current frame, and output a peripheral processing value; and
an information combining convolutional neural network configured to calculate the center processing value and the peripheral processing value, and output an output image,
wherein the center frame processing convolutional neural network does not refer to a center pixel of the current frame.

2. The apparatus of claim 1, wherein the center frame processing convolutional neural network is configured to further receive the peripheral processing value.

3. The apparatus of claim 1, wherein the peripheral frame processing convolutional neural network refers to a center pixel of the past frame and a center pixel of the future frame.

4. The apparatus of claim 1, wherein an impulse response of the center frame processing convolutional neural network has an impulse value for an impulse area having a predetermined size, which surrounds the center pixel of the current frame, without having a center impulse value corresponding to the center pixel of the current frame.

5. The apparatus of claim 1, wherein the center frame processing convolutional neural network includes a convolution operation, and a plurality of dilated convolution operations sequentially disposed and configured to receive a result of the convolution operation, and
a size of a kernel of the dilated convolution operation is greater than a size of a kernel of the convolution operation.

6. The apparatus of claim 5, wherein the kernel of the convolution operation has a first value in a first row and a first column, a second value in the first row and a second column, a third value in the first row and a third column, a fourth value in a second row and the first column, a fifth value in the second row and the third column, a sixth value in a third row and the first column, a seventh value in the third row and the second column, and an eighth value in the third row and the third column without having a value in the second row and the second column corresponding to the center pixel of the current frame.

7. The apparatus of claim 6, wherein an impulse response of the convolution operation has a first impulse value in a first row and a first column, a second impulse value in the first row and a second column, a third impulse value in the first row and a third column, a fourth impulse value in a second row and the first column, a fifth impulse value in the second row and the third column, a sixth impulse value in a third row and the first column, a seventh impulse value in the third row and the second column, and an eighth impulse value in the third row and the third column without having an impulse value in the second row and the second column corresponding to the center pixel of the current frame.

8. The apparatus of claim 6, wherein a kernel of a first dilated convolution operation has a first value in a first row and a first column, a second value in the first row and a third column, a third value in the first row and a fifth column, a fourth value in a third row and the first column, a fifth value in the third row and the fifth column, a sixth value in a fifth row and the first column, a seventh value in the fifth row and the third column, and an eighth value in the fifth row and the fifth column without having a value in the third row and the third column corresponding to the center pixel of the current frame, and without having values in a second row, a fourth row, a second column, and a fourth column.

9. The apparatus of claim 8, wherein an impulse response of the first dilated convolution operation has impulse values in areas other than a fourth row and a fourth column corresponding to the center pixel of the current frame, respectively, without having an impulse value in the fourth row and the fourth column in a matrix having seven rows and seven columns.

10. The apparatus of claim 8, wherein a kernel of a second dilated convolution operation has a first value in a first row and a first column, a second value in the first row and a fifth column, a third value in the first row and a ninth column, a fourth value in a fifth row and the first column, a fifth value in the fifth row and the ninth column, a sixth value in a ninth row and the first column, a seventh value in the ninth row and the fifth column, and an eighth value in the ninth row and the ninth column without having a value in the fifth row and the fifth column corresponding to the center pixel of the current frame, and without having values in second to fourth rows, sixth to eighth rows, second to fourth columns, and sixth to eighth columns.

11. The apparatus of claim 1, wherein the center frame processing convolutional neural network does not refer to a center pixel group of the current frame, which includes the center pixel of the current frame and a plurality of peripheral pixels adjacent to the center pixel.

12. The apparatus of claim 11, wherein the center frame processing convolutional neural network includes a convolution operation, and a plurality of dilated convolution operations sequentially disposed and configured to receive a result of the convolution operation, and
a size of a kernel of the dilated convolution operation is greater than a size of a kernel of the convolution operation.

13. The apparatus of claim 12, wherein the kernel of the convolution operation has a first value in a first row and a first column, a second value in the first row and a second column, a third value in the first row and a third column, a fourth value in the first row and a fourth column, a fifth value in the first row and a fifth column, a sixth value in a second row and the first column, a seventh value in the second row and the fifth column, an eighth value in a third row and the first column, a ninth value in the third row and the second column, a 10^{th} value in the third row and the third column, an 11^{th} value in the third row and the fourth column, and a 12^{th} value in the third row and the fifth column without having values in the second row and the second column, the second row and the third column, and the second row and the fourth column, which correspond to the center pixel group of the current frame.

14. The apparatus of claim 13, wherein an impulse response of the convolution operation has a first impulse value in a first row and a first column, a second impulse value in the first row and a second column, a third impulse value in the first row and a third column, a fourth impulse value in the first row and a fourth column, a fifth impulse value in the first row and a fifth column, a sixth impulse value in a second row and the first column, a seventh impulse value in the second row and the fifth column, an eighth impulse value in a third row and the first column, a ninth impulse value in the third row and the second column, a 10^{th} impulse value in the third row and the third column, an 11^{th} impulse value in the third row and the fourth column, and a 12^{th} impulse value in the third row and the fifth column without having impulse values in the second row and the second column, the second row and the third column, and the second row and the fourth column, which correspond to the center pixel group of the current frame.

15. The apparatus of claim 13, wherein a kernel of a first dilated convolution operation has a first value in a first row and a first column, a second value in the first row and a fourth column, a third value in the first row and a seventh column, a fourth value in a third row and the first column, a fifth value in the third row and the seventh column, a sixth value in a fifth row and the first column, a seventh value in the fifth row and the fourth column, and an eighth value in the fifth row and the seventh column without having values in the third row and a third column, the third row and the fourth column, and the third row and a fifth column, which correspond to the center pixel group of the current frame, and without having values in a second row, a fourth row, second to third columns, and fifth to sixth columns.

16. The apparatus of claim 15, wherein an impulse response of the first dilated convolution operation has impulse values in areas other than a fourth row and a fifth column, the fourth row and a sixth column, and the fourth row and a seventh column, which correspond to the center pixel group of the current frame, respectively, without having an impulse value in the fourth row and the fifth column, the fourth row and the sixth column, and the fourth row and the seventh column in a matrix having seven rows and 11 columns.

17. The apparatus of claim 1, wherein the center frame processing convolutional neural network includes:
a first sequential path configured to receive the peripheral processing value, and sequentially perform a convolution operation; and
a second sequential path configured to receive the current frame, and sequentially perform a convolution operation.

18. The apparatus of claim 17, wherein a number of convolution operation layers of the first sequential path is less than a number of convolution operation layers of the second sequential path.

19-26. (canceled)

27. An apparatus for removing a noise in a time-lapse image, the apparatus comprising:
a center frame processing convolutional neural network configured to receive a current frame of an input image, and output a center processing value;
a peripheral frame processing convolutional neural network configured to receive a plurality of past frames adjacent to the current frame and a plurality of future frames adjacent to the current frame, and output a peripheral processing value; and
an information combining convolutional neural network configured to calculate the center processing value and the peripheral processing value, and output an output image,
wherein a center value of a kernel of the center frame processing convolutional neural network corresponds to a center pixel of the current frame, and
the center value of the kernel is set to 0.

28. A method for removing a noise in a time-lapse image, the method comprising:
receiving a current frame of an input image, and generating a center processing value;
receiving a plurality of past frames adjacent to the current frame and a plurality of future frames adjacent to the current frame, and generating a peripheral processing value; and
calculating the center processing value and the peripheral processing value, and outputting an output image,
wherein a center frame processing convolutional neural network configured to generate the center processing value does not refer to a center pixel of the current frame.

29-31. (canceled)
